(19) United States
(12) Patent Application Publication
(10) Pub. No.: US 2026/0124833 A1
(43) Pub. Date: May 7, 2026

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: KENTARO TAKAHASHI, Tokyo (JP)

(21) Appl. No.: 19/377,459

(22) Filed: Nov. 3, 2025

(30) Foreign Application Priority Data
Nov. 5, 2024 (JP) 2024-193957

(51) Int. Cl. B41J 2/165; B41J 2/045; B41J 2/21; B41J 29/17

(52) U.S. Cl. CPC B41J 2/16502; B41J 2/04573; B41J 2/21; B41J 29/17

(57) ABSTRACT

The image processing apparatus comprising: a nozzle capable of discharging ink toward a sheet; one or more memory devices that store a set of instructions; and one or more processors that execute the set of instructions to: control a timing of discharging the ink from the nozzle, wherein the one or more processors execute instructions in the one or more memory devices to: execute a first determination of whether or not there is printing using ink for which a predetermined period has elapsed since a past time of use; execute the printing if it is determined that there is printing using ink for which the predetermined period has elapsed; and execute cleaning processing for discharging this ink to the nozzle without executing the printing if it is determined that there is no printing using ink for which the predetermined period has elapsed.

### BACKGROUND

### Field of the Technology

The present disclosure relates to an image processing apparatus, a control method for an image processing apparatus, and a storage medium.

### Description of the Related Art

Inkjet image processing apparatuses have become widespread due to the advantage that power consumption can be reduced. In an inkjet method, printing is performed by jetting ink from a nozzle. However, there is a possibility that the nozzle will be clogged when ink adhering to the vicinity of the opening of the nozzle head dries. In view of this, in order to prevent drying, the image processing apparatus includes a cleaning function that jets ink not for the purpose of printing. For example, Japanese Patent Laid-Open No. 2021-111039 proposes a mechanism for executing cleaning upon referring to a use history of a user.

Since the above-described cleaning method consumes ink, it increases the financial burden.

### SUMMARY

The present disclosure enables realization of a new mechanism by which the cost of cleaning a nozzle can be reduced as much as possible in an image processing apparatus.

One aspect of the present disclosure provides an image processing apparatus comprising: a nozzle capable of discharging ink toward a sheet; one or more memory devices that store a set of instructions; and one or more processors that execute the set of instructions to: control a timing of discharging the ink from the nozzle, wherein the one or more processors execute instructions in the one or more memory devices to: execute a first determination of whether or not there is printing using ink for which a predetermined period has elapsed since a past time of use; execute the printing if it is determined that there is printing using ink for which the predetermined period has elapsed; and execute cleaning processing for discharging this ink to the nozzle without executing the printing if it is determined that there is no printing using ink for which the predetermined period has elapsed.

Another aspect of the present disclosure provides a method for controlling an image processing apparatus, the method comprising: discharging ink toward a sheet by a nozzle; and controlling a timing of discharging the ink from the nozzle, wherein a first determination of whether or not there is printing using ink for which a predetermined period has elapsed since a past time of use is executed, if it is determined that there is printing using ink for which the predetermined period has elapsed, the printing is executed, and if it is determined that there is no printing using ink for which the predetermined period has elapsed, cleaning processing for discharging this ink to the nozzle without executing the printing is executed.

Still another aspect of the present disclosure provides a non-transitory computer-readable storage medium storing a program for causing a computer to execute each step in a control method for an image processing apparatus, wherein the control method includes: discharging ink toward a sheet by a nozzle; and controlling a timing of discharging the ink from the nozzle, wherein a first determination of whether or not there is printing using ink for which a predetermined period has elapsed since a past time of use is executed, if it is determined that there is printing using ink for which the predetermined period has elapsed, the printing is executed, and if it is determined that there is no printing using ink for which the predetermined period has elapsed, cleaning processing for discharging this ink to the nozzle without executing the printing is executed.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a hardware configuration diagram of an image processing apparatus according to an embodiment.

FIG. 2 is a software configuration diagram of an image processing apparatus according to an embodiment.

FIG. 3 a schematic view of an inkjet nozzle of an image processing apparatus according to an embodiment FIG. 4 is a function block diagram of an image processing apparatus according to an embodiment.

FIGS. 5A and 5B are diagrams showing information managed by an image processing apparatus according to an embodiment.

FIG. 6 is a flowchart showing a processing procedure of an image processing apparatus according to an embodiment.

FIG. 7 is a flowchart showing a processing procedure of an image processing apparatus according to an embodiment.

FIG. 8 is a flowchart showing a processing procedure of an image processing apparatus according to an embodiment.

FIG. 9 is a flowchart showing a processing procedure of a user terminal according to an embodiment.

FIGS. 10A and 10B are diagrams showing a display screen of an image processing apparatus according to an embodiment.

FIG. 11 is a diagram showing a display screen of an image processing apparatus according to an embodiment.

FIG. 12 is a diagram showing a display screen of an image processing apparatus according to an embodiment.

FIG. 13 is a flowchart showing a processing procedure of an image processing apparatus according to an embodiment.

FIG. 14 is a flowchart showing a processing procedure of an image processing apparatus according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present specification, the term “image processing apparatus” is assumed to encompass a wide range of apparatuses for forming (recording) an image on a recording material (recording medium), such as a single function printer, a copier, a multi-function printer, and a commercial printing machine. In addition, an image processing apparatus may be a system (image processing system) in which an image processing apparatus that forms an image on a recording material and an apparatus such as a sheet processing apparatus or a sheet feeding apparatus are joined to each other.

In this embodiment, a mechanism in which an image processing apparatus 100 provides, for example, eco-printing, will be described. In recent years, there has been increasing need for a function for reducing environmental load due to an increase in the environmental awareness of users. Eco-printing meets this need. That is, an image processing apparatus according to a comparative example immediately provides a user with printed matter by executing printing at a timing instructed by the user. On the other hand, in eco-printing provided by the image processing apparatus 100 according to the present embodiment, in exchange for making the user wait to obtain printed matter, the environmental load is reduced by reducing ink consumption resulting from cleaning.

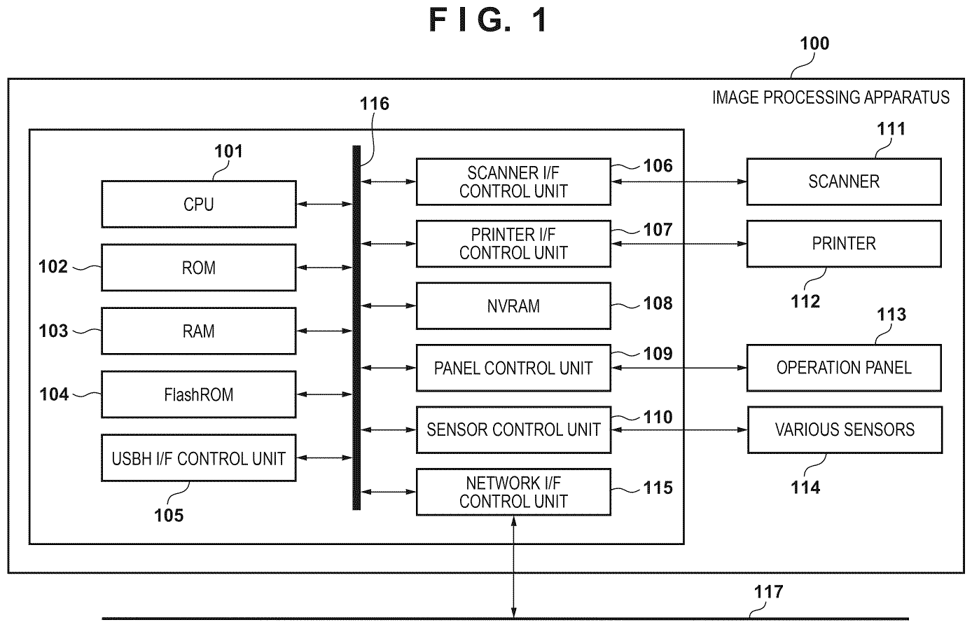

A hardware configuration of the image processing apparatus 100 according to the embodiment will be described with reference to FIG. 1. The image processing apparatus 100 includes a CPU 101, a ROM 102, a RAM 103, a Flash ROM 104, and a USBH I/F control unit 105. The CPU 101 executes a software program of the image processing apparatus 100 and performs overall control of the apparatus. The ROM 102 is a read-only memory and stores a boot program and fixed parameters for the apparatus, and the like. The RAM 103 is a random-access memory and is used for temporarily storing data or the like when the CPU 101 controls the apparatus. The Flash ROM 104 is a rewritable non-volatile memory, and is used to store various types of data such as installed applications, data of applications, and print data. The USBH I/F control unit 105 is for controlling a USB host interface, and controls communication with various USB devices. Note that the CPU 101 is an example of “a control unit capable of controlling a timing of discharging ink from a nozzle”.

The image processing apparatus 100 also includes a scanner I/F control unit 106, a printer I/F control unit 107, an NVRAM 108, a panel control unit 109, a sensor control unit 110, a network I/F control unit 115, and a bus 116. The image processing apparatus 100 also includes a scanner 111, a printer 112, an operation panel 113, and various sensors 114.

The scanner I/F control unit 106 controls the scanner 111. The printer I/F control unit 107 controls the printer 112. The printer 112 is of an inkjet type, for example, and includes a nozzle capable of jetting ink toward a sheet (an example of “being capable of discharging”). A nozzle is provided for each color of ink. The NVRAM 108 is a non-volatile memory, and stores various setting values of the image processing apparatus 100. The panel control unit 109 controls the operation panel 113 to display various types of information, receive instruction input of a user, read user information, and the like. The operation panel 113 includes, for example, a touch panel display and a card reader capable of reading a card that stores user information. Note that the touch panel display may be replaced by, for example, a monitor and a press-operable button.

The sensor control unit 110 is a device for controlling the various sensors 114. A sensor is, for example, a human presence sensor or the like that determines whether or not a person is present in front of the image processing apparatus. The network I/F control unit 115 includes a communication module such as a network interface card (NIC), and controls transmission and reception of data to and from a LAN network 117. The bus 116 is a system bus through which control signals from the CPU 101 and data signals transmitted between apparatuses are transmitted and received. The bus 116 is connected to the CPU 101, the ROM 102, the RAM 103, and the Flash ROM 104. The USBH I/F control unit 105, the scanner I/F control unit 106, the printer I/F control unit 107, the NVRAM 108, the panel control unit 109, the sensor control unit 110, and the network I/F control unit 115 are connected to the bus 116.

Note that the CPU 101 can function as various methods by executing the program. Note that a control circuit such as an ASIC operating in cooperation with the CPU 101 may also function as these methods. In addition, the CPU 101 may realize these methods through cooperation between the CPU 101 and a control circuit that controls the operation of the image processing apparatus 100. In addition, the CPU 101 does not need to be a single CPU, and may be a plurality of CPUs. In this case, the plurality of CPUs 101 can execute the processing in a distributed manner. Also, the plurality of CPUs 101 may be arranged in a single computer, or may be arranged in a plurality of physically different computers. Note that the method realized by the CPU 101 executing the program may be realized by a dedicated circuit.

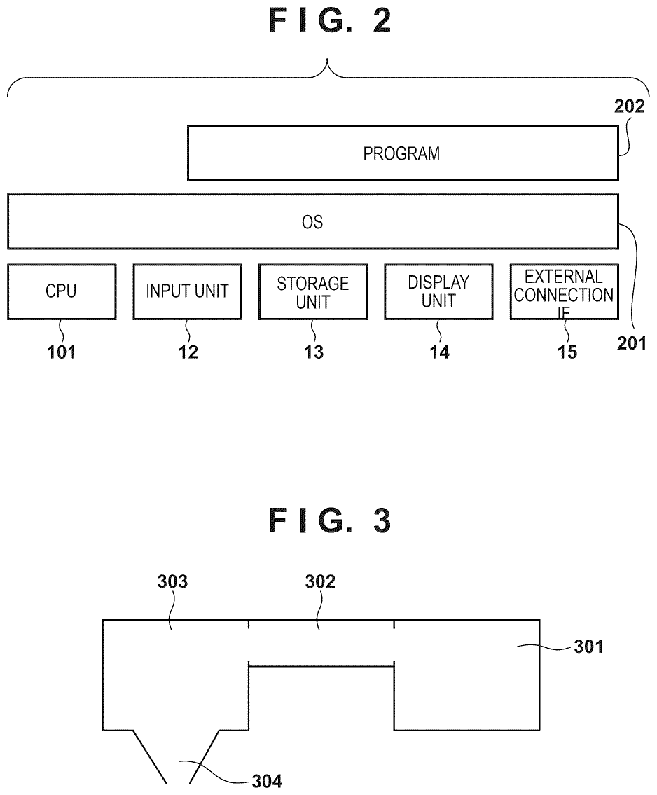

A software configuration constructed on the image processing apparatus 100 will be described with reference to FIG. 2. An operating system 201 (hereinafter referred to as an OS 201) is software serving as the basis of the entire system. A program 202 is software that is to operate on the OS 201. An input unit 12 corresponds to the scanner I/F control unit 106, the printer I/F control unit 107, and the sensor control unit 110. A storage unit 13 corresponds to the ROM 102, the RAM 103, the Flash ROM 104, and the NVRAM 108. A display unit 14 corresponds to the panel control unit 109. An external connection IF 15 corresponds to the network I/F control unit 115.

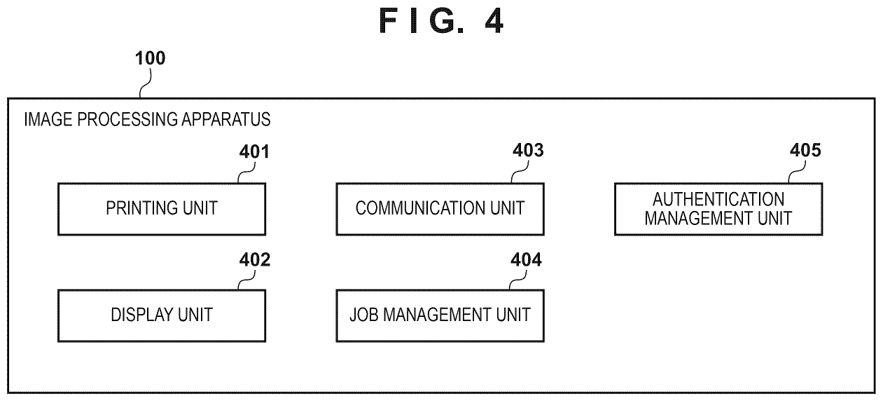

The structure of a nozzle portion of the printer 112 will be described in detail with reference to FIG. 3. The printer 112 includes an ink chamber 301 for storing ink, a pressure chamber 303 for applying pressure to ink, and a flow path 302 that connects the ink chamber 301 and the pressure chamber 303 and allows ink to flow from the pressure chamber 303 to the ink chamber 301. A nozzle 304 is provided on one surface of the pressure chamber 303. Ink to which pressure is applied is ejected toward a sheet from an opening at the head of the nozzle 304.

Function blocks of the image processing apparatus 100 will be described with reference to FIG. 4. The image processing apparatus 100 includes a printing unit 401, a display unit 402, a communication unit 403, a job management unit 404, and an authentication management unit 405. The printing unit 401 executes printing. The communication unit 403 communicates with an external device. The display unit 402 displays a screen. The authentication management unit 405 manages user login authentication. The job management unit 404 manages a received printing job.

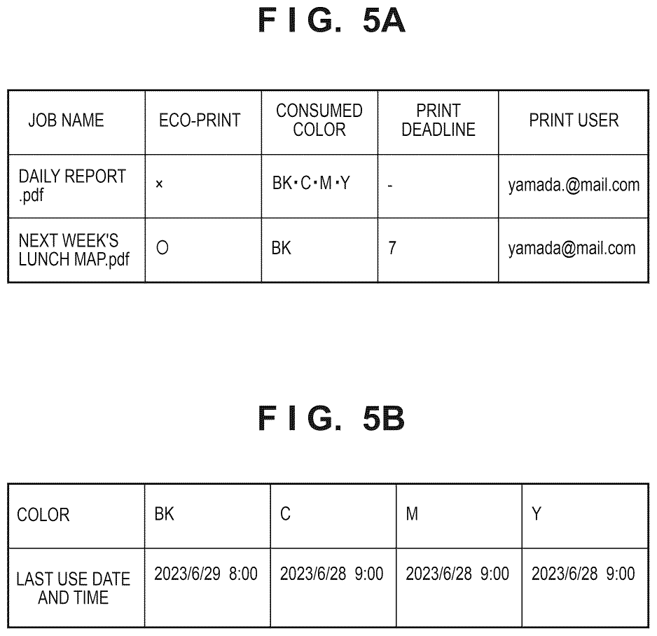

The information managed by the job management unit 404 will be described with reference to FIGS. 5A and 5B. The job management unit 404 stores and manages job information and ink use history information in a storage medium such as the NVRAM 108. FIG. 5A illustrates the job information managed by the job management unit 404 in list format. A job name and the color of the ink consumed by the job are recorded in the job information. The information of the user who transmitted the job is recorded as a printing user in the job information. In FIG. 5A, the information of the user is, for example, an e-mail address.

Furthermore, the job information includes an eco-printing setting indicating that the user has left the timing of printing the job up to the image processing apparatus 100. A printing job for which eco-printing is designated is automatically executed at a timing at which it is estimated that the ink adhering to the inkjet nozzle will dry and clog the nozzle. Note that the timing at which the nozzle is clogged may be estimated, for example, through machine learning in which an ink use history (FIG. 5B) or failure history is stored in a storage medium and these histories are used as training data, or may be estimated based on an experimental result for the solidification time of the ink. Accordingly, the number of instances of cleaning the nozzle can be reduced. Note that details of the processing for designating eco-printing will be described later. The job information also includes a printing deadline date and time. By setting such a printing deadline date and time, the printing time limit can be managed.

FIG. 5B illustrates the ink use history information managed by the job management unit 404 in list format. The ink use history information is used to estimate the timing when ink adhering to the inkjet nozzle dries and clogs the nozzle. The ink use history information includes the date and time when each color was last used. Note that BK indicates black, C indicates cyan, M indicates magenta, and Y indicates yellow.

### Processing Example 1

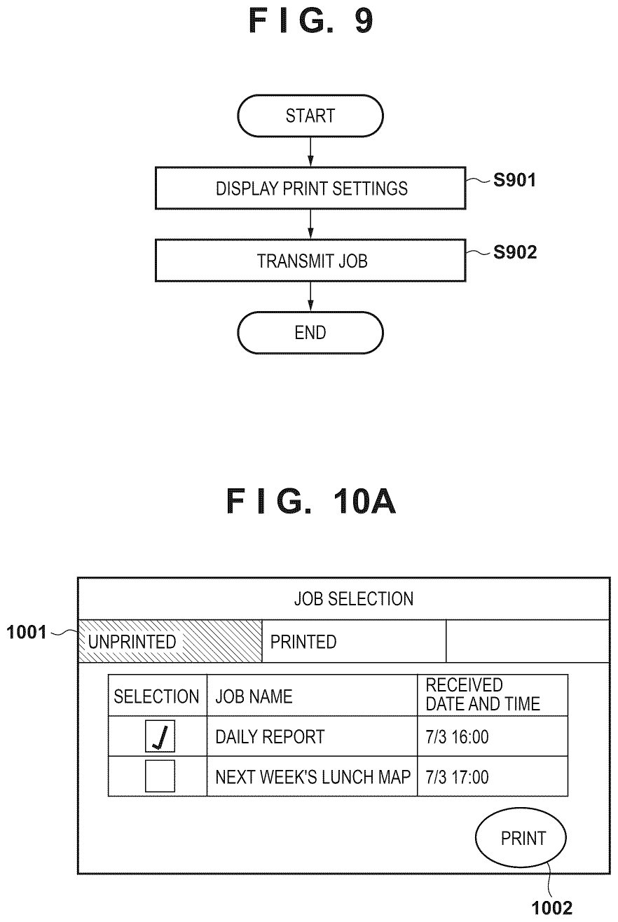

Processing for transmitting a print job from a user terminal to the image processing apparatus 100 will be described with reference to FIG. 9. Note that the user terminal is an electronic device such as a personal computer or a smartphone, for example. The user terminal includes a storage medium such as a CPU, a RAM, a ROM, or an HDD, a module capable of input operation on a touch panel display or the like and screen display, and a communication module capable of network connection. Also, the CPU reads out and executes a control program stored in the ROM to control the constituent units, thereby realizing the following processing.

In step S901, the CPU of the user terminal displays print settings on the touch panel display by executing a driver program for transmitting a print job to the image processing apparatus 100. The print settings include a setting as to whether or not eco-printing is to be performed. Note that the driver is installed in the user terminal in advance.

In step S902, the CPU of the user terminal receives operation input for the printing settings. Then, the CPU generates job data in accordance with the operation input. Note that the printing target is stored in advance as electronic data in the storage medium of the user terminal. Then, the CPU transmits the print job to the image processing apparatus 100 using the communication module. Then, the processing ends.

### Processing Example 2

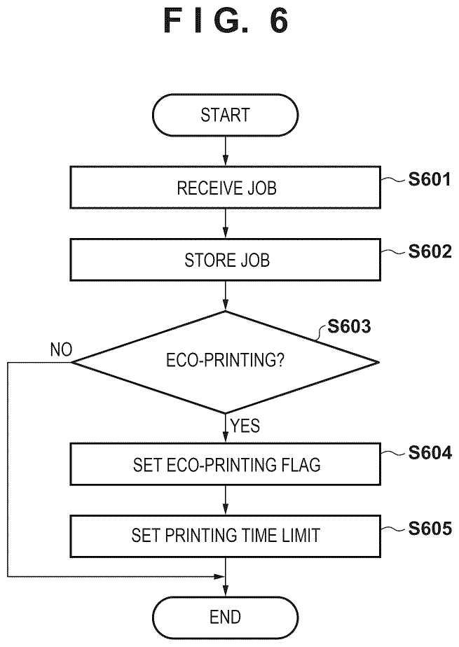

Processing executed by the image processing apparatus 100 for receiving the print job transmitted from the user terminal as described above will be described with reference to FIG. 6. Note that such processing is realized by the CPU 101 of the image processing apparatus 100 reading out a program stored in a storage medium such as the ROM 102, and controlling the above-described constituent units.

In step S601, the CPU 101 receives the print job transmitted from the user terminal using the network I/F control unit 115. In step S602, the CPU 101 stores the received print job in a storage medium such as the NVRAM 108. In step S603, the CPU 101 determines whether or not eco-printing has been set for the print job. If the CPU 101 determines that eco-printing has been set, the processing proceeds to step S604, and if not, the processing ends.

In step S604, the CPU 101 sets an eco-printing flag. In step S605, if a printing time limit is included in the print job, the CPU 101 sets the printing time limit. In addition, the CPU 101 adds the print job set in this manner to the job information managed by the job management unit 404 as shown in FIG. 5A. Then, the processing ends.

### Processing Example 3

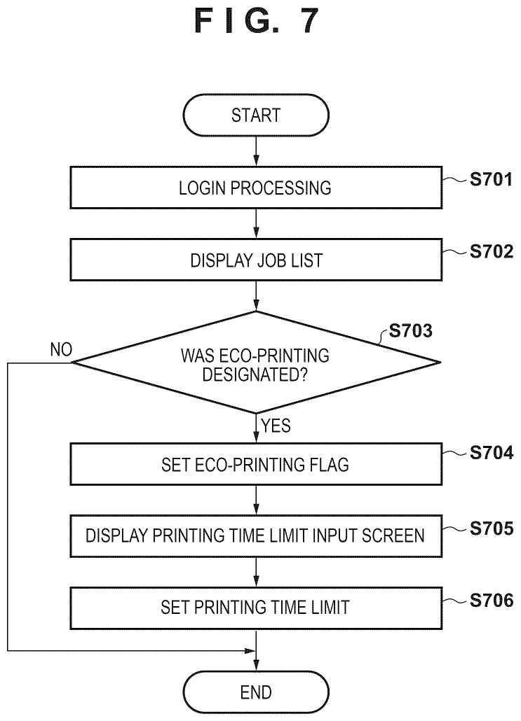

Processing performed when a user logs in to the image processing apparatus 100 will be described with reference to FIG. 7. Note that such processing is realized by the CPU 101 of the image processing apparatus 100 reading out a program stored in a storage medium such as the ROM 102, and controlling the above-described constituent units.

In step S701, the CPU 101 of the image processing apparatus 100 reads the user information from a card connected to the card reader via the panel control unit 109. Note that user verification is not limited to this method. For example, the CPU 101 may receive an operation of inputting a login ID and password of the user on the operation panel 113 using the panel control unit 109 and perform user verification. Alternatively, in the case of a home or a small-scale office, this login step may be omitted.

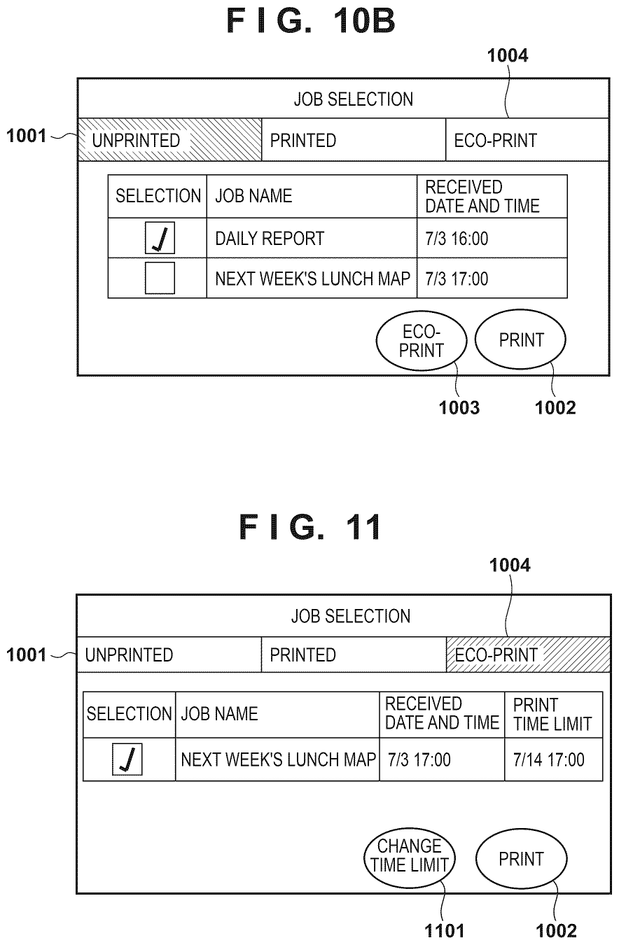

In step S702, the CPU 101 displays the print jobs of the user in list format on the screen of the operation panel 113 after login authentication. The display screen of operation panel 113 will be described with reference to FIGS. 10A and 10B. FIG. 10A illustrates a display screen according to a comparative example, and FIG. 10B illustrates a display screen on the operation panel 113 according to the present embodiment.

On the display screen of the comparative example shown in FIG. 10A, jobs are classified into an unprinted tab 1001 and a printed tab. On the screen in which the unprinted tab 1001 is selected, two jobs are displayed in list format. The user selects a job for which printing is desired on the screen and performs a touch operation on a print execution button 1002 to execute printing.

On the other hand, on the display screen according to the present embodiment shown in FIG. 10B, an eco-printing tab 1004 is added. When a job is selected, not only the print execution button 1002 but also an eco-printing button 1003 is displayed. When a touch operation is performed on the eco-printing button 1003, that job is displayed on the display screen shown when the eco-printing tab 1004 is selected. FIG. 11 illustrates the display screen shown when the eco-printing tab 1004 is selected. On the display screen shown in FIG. 11, a print execution button 1002 and a time limit changing button 1101 are displayed in addition to the job moved by performing a touch operation on the eco-printing button 1003. The time limit changing button 1101 is a button for changing a time limit set in advance for the print job. In addition, the print execution button 1002 is a button for operating in a case where the situation changes after eco-printing is designated and the user wishes to print immediately. Note that the time limit changing button 1101 is an example of a “first object indicating that a time limit for executing eco-printing is to be changed”. The print execution button 1002 is an example of a “second object for instructing a start of execution of eco-printing”.

The description of the flowchart of FIG. 7 will be returned to. In step S703, the CPU 101 determines whether or not the eco-printing button 1003 shown in FIG. 10B has been operated. Then, if the CPU 101 determines that the eco-printing button 1003 has been operated, the processing proceeds to step S704, and if not, the processing ends.

In step S704, the CPU 101 (an example of a “reception unit”) sets an eco-printing flag for the print job and stores it in a storage medium as job information. In step S705, if operation of the time limit changing button 1101 shown in FIG. 11B has been accepted, the CPU 101 displays a printing time limit input screen. In step S706, the CPU 101 stores the printing time limit input on the printing time limit input screen as job information in the storage medium. Then, the processing ends.

### Processing Example 4

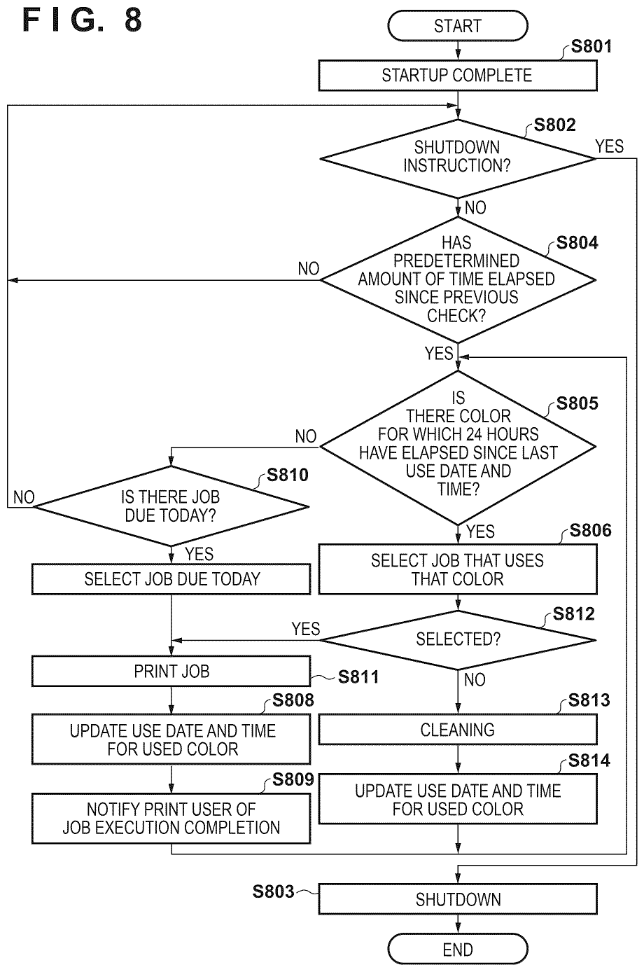

Processing in which the image processing apparatus 100 uses eco-printing to prevent drying of the ink adhering to the inkjet nozzle will be described with reference to FIG. 8. Note that such processing is realized by the CPU 101 of the image processing apparatus 100 reading out a program stored in a storage medium such as the ROM 102, and controlling the above-described constituent units.

In step S801, the CPU 101 performs startup processing in response to powering-on of the image processing apparatus 100 and completes the startup of the image processing apparatus 100. In step S802, the CPU 101 determines whether or not there is a shutdown instruction. If the CPU 101 determines that there is a shutdown instruction, the processing proceeds to step S803, the CPU 101 performs shutdown processing, and the processing ends. On the other hand, if the CPU 101 determines that there is no shutdown instruction, the processing proceeds to step S804.

In step S804, the CPU 101 determines whether or not a predetermined amount of time has elapsed since the previous check of execution of eco-printing. The value of the predetermined amount of time is not particularly limited, but may be fixed, for example, every hour or the like, or may be changed in accordance with the season or humidity. If the CPU 101 determines that the predetermined amount of time has elapsed, the processing proceeds to step S805, and if not, the processing returns to step S802.

In step S805, the CPU 101 determines whether or not there is ink of a color for which 24 hours or more has elapsed since the date and time when it was last used for printing (an example of “a predetermined period having elapsed since a past time of use) (an example of a “second determination”). The determination is executed for each color by the CPU 101 referring to the use date and time of each color described in the table of FIG. 5B, for example. Note that the elapsed amount of time is set to a timing at which the CPU 101 estimates that the ink adhered to the nozzle will dry and clog the nozzle, as described above. Although the elapsed amount of time is set to, for example, 24 hours, the CPU 101 may change the elapsed amount of time according to the color of the ink, the season, or the humidity. If the CPU 101 determines that there is ink of a color for which 24 hours or more has elapsed, the processing proceeds to step S806, and if not, the processing proceeds to step S810.

In step S806, the CPU 101 selects a job using the color determined in step S805 from among the print jobs stored in the storage medium (e.g., see FIG. 5A) in order to prevent drying of the ink of that color. In step S812, the CPU 101 determines whether or not job selection was successful (an example of a “second determination”). If the CPU 101 determines that job selection was successful, the processing proceeds to step S807. On the other hand, if the CPU 101 determines that job selection was unsuccessful, the processing proceeds to step S813.

In step S807, the CPU 101 executes the print job using the printer 112. That is, the CPU 101 supplies ink set in the print job to the nozzle. Then, the CPU 101 controls the ink pressure to jet ink from the nozzle head of the printer 112 toward the sheet. In this way, the ink adhering to the nozzle head is prevented from drying. In step S808, the CPU 101 stores the use date and time of the used ink in a storage medium such as the NVRAM 108. Note that if the use date and time are stored in advance in the storage medium, the CPU 101 overwrites the stored use date and time to update the use date and time. Then, in step S809, the CPU 101 uses the network I/F control unit 115 to transmit a print completion notification to the printing user who created the job. The notification method is not particularly limited, and may be a notification by e-mail, for example. Then, the processing returns to step S805.

On the other hand, if job selection was unsuccessful in step S812, the CPU 101 supplies the corresponding ink to the nozzle without executing printing in order to clean the nozzle head that is to jet the ink of the corresponding color, in step S813. Then, the CPU 101 causes the nozzle head to jet the ink by applying pressure. In this way, the ink adhering to the nozzle head is prevented from drying. In step S814, the CPU 101 updates the use date and time of the ink and stores the updated use date and time in a storage medium. Then, the processing returns to step S805. Note that depending on the type of the image processing apparatus 100, it is necessary to allow a predetermined period (e.g., a longer amount of time than the amount of time of the determination condition in step S805) to elapse from the previous jetting of the ink in order to execute cleaning. In such a case, if the predetermined period has not elapsed, the cleaning processing in step S813 may be skipped.

If the CPU 101 determines in step S805 that there is no color for which 24 hours has elapsed, in step S810, the CPU 101 confirms whether or not there is a print job whose deadline is the current date (an example of a “print job for which a current date has been set as a deadline”). Then, if the CPU 101 determines that there is no print job whose deadline is the current date, the processing returns to step S802. On the other hand, if the CPU determines that there is a print job whose deadline is the current date, the processing proceeds to step S811. In step S811, the CPU 101 selects the print job whose deadline is the current date from among the print jobs stored in the storage medium. Then, the processing proceeds to step S807, and the CPU 101 executes the print job. Thereafter, the processing proceeds in the order of step S808 and step S809, and returns to step S805.

### Aspect of Actions and Effects

According to the image processing apparatus 100 as described above, a print job or cleaning is executed at a timing at which it is estimated that the ink adhering to the nozzle head will dry and clog the nozzle. Accordingly, the nozzle head is prevented from being clogged. The execution of the print job is used to prevent the ink adhering to the nozzle head from drying. Accordingly, the number of instances of cleaning is reduced, and as a result, consumption of ink is suppressed. Thus, the cost of cleaning the nozzle is reduced.

### Modification 1

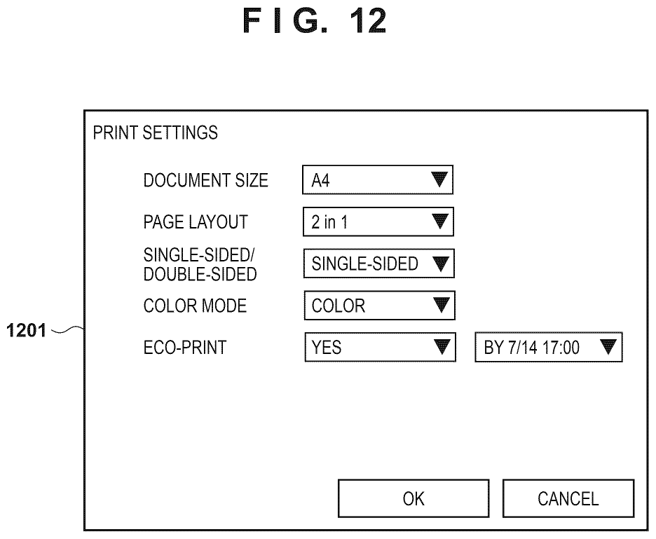

In the above-described embodiment, the setting of eco-printing is executed via the screen displayed on the operation panel as shown in FIG. 10B. On the other hand, in a first modification, the setting of eco-printing is executed at a user terminal. More specifically, a print setting screen 1201 of the user terminal will be described with reference to FIG. 12. Note that this processing is realized by the user terminal and the CPU of the image processing apparatus reading out and executing control programs stored in the storage media and controlling the constituent units.

In the first modification, the CPU of the user terminal displays the print setting screen 1201 on the touch panel display in step S901. In the print setting screen 1201, for example, general setting items such as document size, page layout, single-sided/double-sided, and color mode are selectably displayed. Furthermore, the print setting screen 1201 selectably displays eco-printing and the printing time limit of eco-printing. The CPU then receives input of eco-printing and the printing time limit of eco-printing on the print setting screen 1201. Then, the CPU uses the communication module to transmit print job information including the received input information to the image processing apparatus 100. Then, the CPU 101 of the image processing apparatus 100 receives the input information using the network I/F control unit 115, sets eco-printing and the printing time limit of eco-printing, and stores them in the storage medium.

### Aspect of Actions and Effects

The image processing apparatus 100 according to the first modification enables setting of eco-printing using a user terminal without the user moving to the image processing apparatus 100. Thus, convenience to the user is improved.

### Modification 2

In the above-described embodiment, in order to prevent the ink adhering to the inkjet nozzle head from drying, ink is ejected from the nozzle by executing printing or cleaning processing periodically. In addition, in the second modification, cleaning liquid that allows cleaning of the nozzle is jetted from the nozzle.

### Processing Example 5

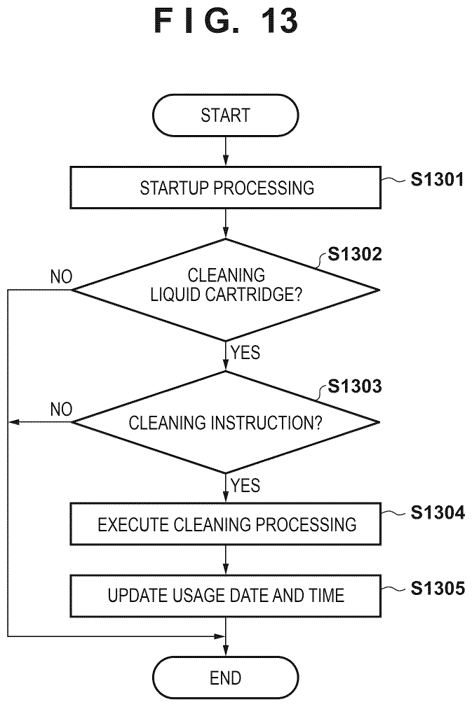

Processing for using the cleaning liquid to prevent the ink adhering to the nozzle head from drying will be described with reference to FIG. 13. Note that such processing is realized by the CPU 101 of the image processing apparatus 100 reading out a program stored in a storage medium such as the ROM 102, and controlling the above-described constituent units.

In step S1301, the CPU 101 performs startup processing in response to powering-on of the image processing apparatus 100 and completes startup of the image processing apparatus 100. In step S1302, the CPU 101 determines whether or not a cartridge of cleaning liquid is attached. If the CPU 101 determines that a cartridge of cleaning liquid is attached, the processing proceeds to step S1303, and if not, the processing ends.

In step S1303, the CPU 101 determines whether or not there is a cleaning instruction. The cleaning instruction is, for example, the CPU 101 receiving a detection signal indicating that a cartridge of cleaning liquid is attached. If the CPU 101 determines that there is a cleaning instruction, the processing proceeds to step S1304, and otherwise, the processing ends. In step S1304, the CPU 101 causes the cleaning liquid to be ejected from the head of the nozzle (cleaning processing). In step S1305, the CPU 101 stores the use date and time of the cleaning liquid in a storage medium such as the NVRAM 108. Note that the CPU 101 may initialize the use date and time of the ink and store the use date and time of the cleaning liquid, or may store the use date and time of the cleaning liquid as a cleaning history separately from the use date and time of the ink in a storage medium.

### Aspect of Actions and Effects

The image processing apparatus 100 according to the second modification causes the cleaning liquid to flow into the nozzle, whereby the ink adhering to the nozzle head can be efficiently removed. Accordingly, the consumption of ink for preventing the clogging of the nozzle is suppressed. Thus, the cost of cleaning is reduced.

### Modification 3

In the above-described embodiment, if there is ink for which 24 hours has elapsed from the last use date and time in step S805, a job for eco-printing job using the ink is selected and executed. However, in an environment where the user often uses black-and-white (including monochrome) printing, there is a possibility that a job for eco-printing using ink of a color other than black and white (monochrome) is not stored. In the third modification, in this case, the black-and-white print job is changed to color printing and executed as an eco-printing job. Note that in the case of monochrome printing, a single ink other than black ink is used.

### Processing Example 6

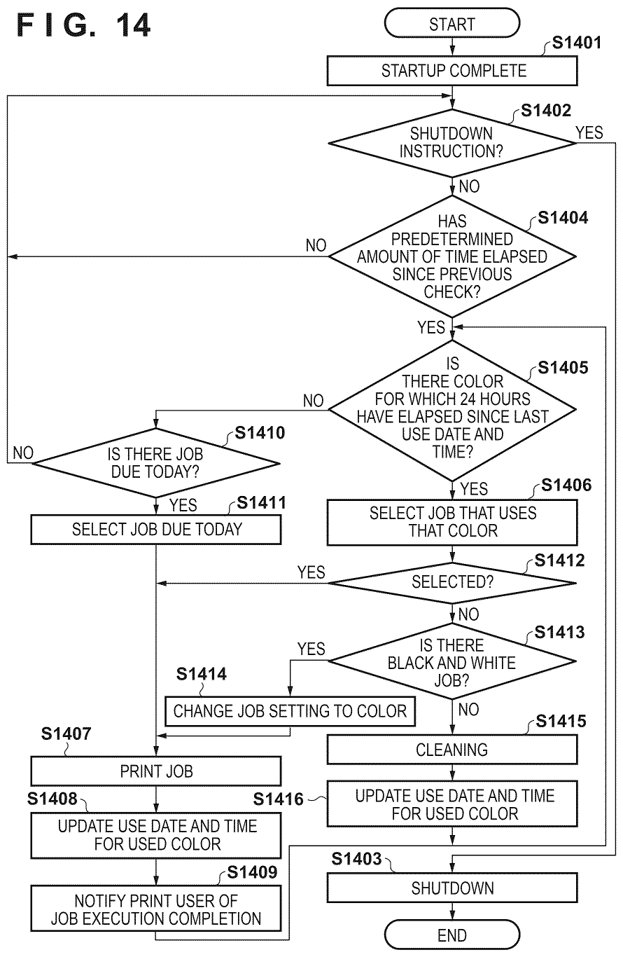

Processing for preventing ink adhering to an inkjet nozzle head according to the third modification from drying will be described with reference to FIGS. 14A and 14B. Note that such processing is realized by the CPU 101 of the image processing apparatus 100 reading out a program stored in a storage medium such as the ROM 102 and controlling the above-described units. In addition, steps S1401 to S1412, S1415, and S1416 are the same as steps S801 to S814 according to the embodiment, and therefore description thereof is omitted.

If the CPU 101 determines that job selection was unsuccessful in step S1412, the CPU 101 determines in step S1413 whether or not there is a print job whose color is set to black and white (an example of a “third determination”). Then, if the CPU 101 determines that the print job exists, the processing proceeds to step S1414. On the other hand, if not, the processing proceeds in the order of step S1415 and step S1416, and returns to step S1405.

In step S1414, the CPU 101 changes the color setting of the print job to color. Thereafter, the processing proceeds in the order of step S1407 and step S1408, and returns to step S1405. Note that in such a case, the CPU 101 may also include the fact that the black-and-white setting has been changed to color in the notification message in step S1409.

### Aspect of Actions and Effects

With the image processing apparatus 100 according to the third modification, the number of instances of cleaning of the nozzle head is reduced by changing an eco-printing job whose color is designated as black-and-white to color printing and executing the color printing to prevent drying of the ink. Thus, the overall amount of ink consumed is reduced.

### Modification 4

An image processing apparatus 100 according to a fourth modification acquires a print job from an external image processing apparatus and executes the print job in order to prevent the ink adhering to the nozzle head from drying. More specifically, in step S805, if the CPU 101 determines that there is a color for which 24 hours have elapsed, the CPU 101 uses the network I/F control unit 115 to request an external apparatus to execute the print job. The CPU 101 then receives and executes the print job. Note that the external apparatus may be a host device in the case where, for example, the image processing apparatus 100 is a client device. Alternatively, the external apparatus is, for example, a cloud storage that stores a print job, and the CPU 101 may acquire the print job stored in the cloud storage. According to this fourth modification, if the CPU 101 determines that there is ink for which 24 hours have elapsed, the ink adhering to the nozzle head can be prevented from drying without cleaning even if there is no eco-printing job using the ink. As a result, the amount of ink consumed is reduced.

### Other Modified Examples

The present disclosure can be embodied as, for example, a system, an apparatus, a method, a program, a recording medium (storage medium), or the like. Specifically, the present disclosure may be applied to a system constituted by a plurality of devices (e.g., a host computer, an interface device, an image capture apparatus, a web application, etc.), and may be applied to a system constituted by a single device.

It goes without saying that the object of the present disclosure is achieved by the following procedure. That is, a recording medium (or storage medium) storing a program code (computer program) of software for realizing the functions of the above-described embodiments is supplied to a system or apparatus. Needless to say, such a storage medium is a computer-readable storage medium. Then, the computer (or CPU or MPU) of the system or apparatus reads out and executes the program code stored in the recording medium. In this case, the program code read out from the recording medium realizes the functions of the embodiments, and the recording medium on which the program code has been recorded constitutes the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-193957, filed Nov. 5, 2024, which is hereby incorporated by reference herein in its entirety.

What is claimed is:

1. An image processing apparatus comprising:
a nozzle capable of discharging ink toward a sheet;
one or more memory devices that store a set of instructions; and
one or more processors that execute the set of instructions to:
control a timing of discharging the ink from the nozzle, wherein the one or more processors execute instructions in the one or more memory devices to:
execute a first determination of whether or not there is printing using ink for which a predetermined period has elapsed since a past time of use;
execute the printing if it is determined that there is printing using ink for which the predetermined period has elapsed; and
execute cleaning processing for discharging this ink to the nozzle without executing the printing if it is determined that there is no printing using ink for which the predetermined period has elapsed.

2. The image processing apparatus according to claim 1,
wherein the one or more processors execute instructions in the one or more memory devices to:
execute a second determination of whether or not there is ink for which the predetermined period has elapsed since a past time of use, before the first determination,
execute the first determination if it is determined that there is ink for which the predetermined period has elapsed since a past time of use; and
execute printing for which a current date is set as a deadline if it is determined that there is no ink for which the predetermined period has elapsed since a past time of use.

3. The image processing apparatus according to claim 1,
wherein the one or more processors execute instructions in the one or more memory devices to:
execute a third determination of whether or not there is monochrome printing, after the first determination;
change the printing to color printing and execute the color printing if it is determined that there is the monochrome printing; and
execute the cleaning processing if it is determined that there is no monochrome printing.

4. The image processing apparatus according to claim 1,
wherein the one or more processors further execute instructions in the one or more memory devices to:
discharge cleaning liquid capable of cleaning the nozzle from the nozzle.

5. The image processing apparatus according to claim 1,
wherein the one or more processors further execute instructions in the one or more memory devices to:
receive setting of the printing to eco-printing in which a timing of executing the printing can be controlled.

6. The image processing apparatus according to claim 5,
wherein the one or more processors further execute instructions in the one or more memory devices to:
display a screen including information on the eco-printing, a first object indicating changing of an execution time limit of the eco-printing, and a second object for instructing a start of execution of the eco-printing; and
accept operation input with respect to the first object and the second object.

7. The image processing apparatus according to claim 5,
wherein the one or more processors further execute instructions in the one or more memory devices to:
receive a job of the eco-printing from an external apparatus.

8. The image processing apparatus according to claim 1,
wherein the one or more processors further execute instructions in the one or more memory devices to:
receive a job for the printing from an external apparatus,
wherein the one or more processors execute instructions in the one or more memory devices to:
execute the received job for the printing if it is determined in the first determination that there is printing using ink for which the predetermined period has elapsed.

9. The image processing apparatus according to claim 1,
wherein the predetermined period is determined based on an ink use history, ink color, season, or humidity.

10. A method for controlling an image processing apparatus, the method comprising:
discharging ink toward a sheet by a nozzle; and
controlling a timing of discharging the ink from the nozzle,
wherein a first determination of whether or not there is printing using ink for which a predetermined period has elapsed since a past time of use is executed,
if it is determined that there is printing using ink for which the predetermined period has elapsed, the printing is executed, and
if it is determined that there is no printing using ink for which the predetermined period has elapsed, cleaning processing for discharging this ink to the nozzle without executing the printing is executed.

11. A non-transitory computer-readable storage medium storing a program for causing a computer to execute each step in a control method for an image processing apparatus, wherein the control method includes:
discharging ink toward a sheet by a nozzle; and
controlling a timing of discharging the ink from the nozzle,
wherein a first determination of whether or not there is printing using ink for which a predetermined period has elapsed since a past time of use is executed,
if it is determined that there is printing using ink for which the predetermined period has elapsed, the printing is executed, and
if it is determined that there is no printing using ink for which the predetermined period has elapsed, cleaning processing for discharging this ink to the nozzle without executing the printing is executed.
